(19) United States
(12) Patent Application Publication
(10) Pub. No.: US 2013/0077673 A1
(43) Pub. Date: Mar. 28, 2013

(54) Multi-processor compression system

(71) Applicant: Rohit Puri, Campbell, CA (US)

(72) Inventor: Rohit Puri, Campbell, CA (US)

(73) Assignee: CISCO TECHNOLOGY, INC., San Jose, CA (US)

(21) Appl. No.: 13/200,467

(22) Filed: Sep. 23, 2011

(51) Int. Cl. H04N 7/26

(52) U.S. Cl. 375/240.03; 375/240.02; 375/E07.139; 375/E07.126

(57) ABSTRACT

In one embodiment, a method includes receiving data for compression at a first network device comprising an initial processing portion of a compression system, performing one or more processes to prepare the data for entropy encoding, compacting the data, and transmitting the compacted data to a second network device comprising an entropy encoding portion of the compression system. The first and second network devices include independent processors. An apparatus and system are also disclosed.

### TECHNICAL FIELD

The present disclosure relates generally to communication networks, and more particularly, to compression systems.

### BACKGROUND

Compression is an important component of many digital systems. Compression systems may be used to compress video, audio, or other data. There are a number of coding standards, including, for example, ITU-T H.262, H.263, and H.264. The newer standards compress video more efficiently than previous standards, however, this increased compression efficiency comes at the cost of additional computation requirements.

### BRIEF DESCRIPTION OF THE FIGURES

FIG. 1 illustrates an example of a network in which embodiments described herein may be implemented.

FIG. 2 depicts an example of a network device useful in implementing embodiments described herein.

FIG. 3 is a block diagram illustrating a multi-processor compression system, in accordance with one embodiment.

FIG. 4 is a flowchart illustrating an overview of a process for performing initial processing and compaction of data in the compression system of FIG. 3, in accordance with one embodiment.

FIG. 5 is a flowchart illustrating an overview of a process for performing interpretation and entropy encoding in the compression system of FIG. 3, in accordance with one embodiment.

Corresponding reference characters indicate corresponding parts throughout the several views of the drawings.

### DESCRIPTION OF EXAMPLE EMBODIMENTS

### Overview

In one embodiment, a method generally comprises receiving data for compression at a first network device comprising an initial processing portion of a compression system, performing one or more processes to prepare the data for entropy encoding, compacting said data, and transmitting the compacted data to a second network device comprising an entropy encoding portion of the compression system. The first and second network devices comprise independent processors.

In another embodiment, an apparatus generally comprises a processor for interpreting compacted data received from an initial processing portion of a compression system, entropy encoding the data, and transmitting a compressed bit stream. The apparatus further includes memory for storing encoding information. The processor is independent from the initial processing portion of the compression system.

In yet another embodiment, a compression system generally comprises an initial processing portion for processing received data to prepare the data for entropy encoding and compacting the data utilizing fixed length encoding, and an entropy encoding portion for interpreting the data received from the initial processing portion and performing entropy encoding. Compaction of the data reduces transmission bandwidth between the initial processing portion and the entropy encoding portion.

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

Processing for video compression systems typically includes pixel domain redundancy removal (motion estimation or intra-prediction) followed by transformation, quantization, and entropy coding of syntax elements. Motion estimation, transformation, and quantization are often amenable to parallel processing implementations. Entropy coding is typically very specific to a particular encoding format and not suitable to parallel processing implementations. Furthermore, entropy coding is often computationally expensive with operations that are highly ‘irregular’ from a hardware point of view.

In conventional systems, the data output from a quantization module and input to an entropy coding module is uncompressed and associated with high bandwidth requirements. This typically necessitates implementation of the complete encoding pipeline on the same physical processor since the transmission of raw pixel or transform data between different modules would be prohibitively expensive in terms of bandwidth requirements.

The embodiments described herein provide an efficient multi-processor implementation for compression systems that allows entropy coding to be implemented separately from other processing. In one embodiment, motion estimation, transformation, and quantization, which are amenable to parallel processing arrangements, are implemented separately from entropy encoding. The embodiments provide for compression (referred to herein as compaction) of data output from an initial processing portion of the encoding pipeline and input to an entropy encoding portion. This architecture allows for remote location of an entropy coding module from the rest of the encoding pipeline and enables realization of new encoding architectures. The embodiments may be used to compress any type of data, including, for example, audio, video, or both audio and video. The embodiments enable efficient communication between the initial processing portion and the entropy encoding portion of the encoding pipeline.

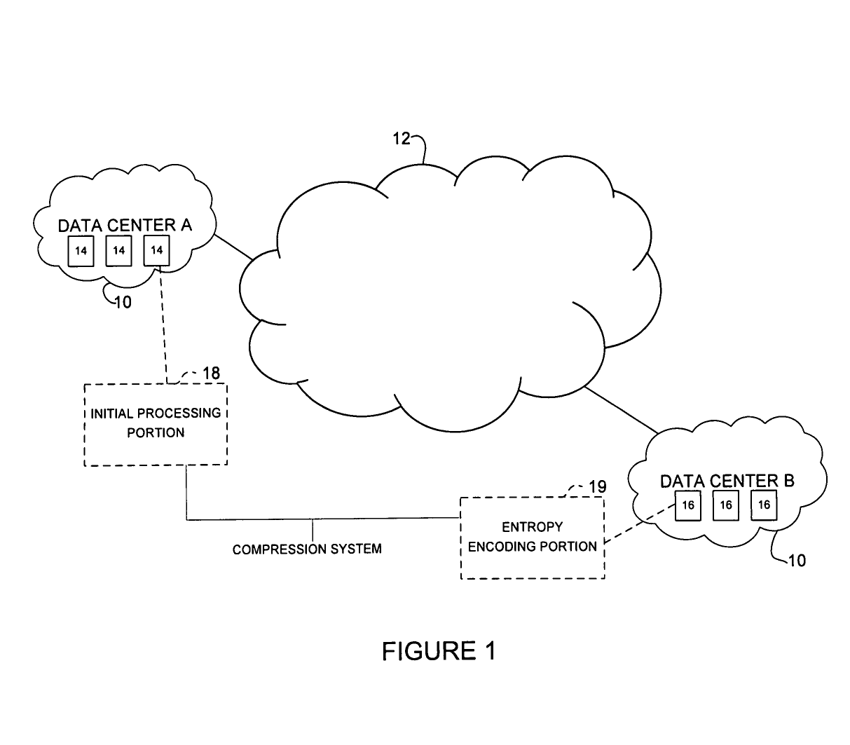

Referring now to the drawings, and first to FIG. 1, an example of a network in which embodiments described herein may be implemented is shown. For simplification, only a small number of network elements are shown. A plurality of networks 10, which may be configured for use as data centers or any other type of networks, are in communication over network 12. The example shown in FIG. 1 includes two data centers (data center A and data center B) 10. The data centers 10 include network devices 14, 16. The network device 14, 16 may be, for example, a server, host, media experience engine, or any other type of network device operable to perform one or more processing functions associated with compression. There may be any number of data centers 10 in communication over network 12 and each data center 10 may include any number of network devices 14, 16. The network devices 14, 16 may be in communication with any number of endpoints (not shown) configured for receiving, transmitting, or receiving and transmitting media flows.

The data center 10 may be an Ethernet network, Fibre Channel (FC) network, Fibre Channel over Ethernet (FCoE) network, or any other type of network. The data center 10 may include any number of servers, switches, storage devices, or other network devices or systems (e.g., video content delivery system).

The network 12 may include one or more networks (e.g., local area network, metropolitan area network, wide area network, virtual private network, enterprise network, Internet, intranet, radio access network, public switched network, or any other network). The network 12 may include any number or type of network devices (e.g., routers, switches, gateways, or other network devices), which facilitate passage of data over the network. The network 12 may also be in communication with one or more other networks, hosts, or users. The networks 10, 12 are connected via communication links. The networks 10, 12 may operate in a cloud computing environment.

In the example shown in FIG. 1, one or more of the network devices 14 comprise an initial processing portion 18 configured for initial processing and compaction (e.g., motion estimation, transformation, quantization, and compaction) and one or more of the network devices 16 comprise an entropy encoding portion 19 configured for interpretation and entropy encoding. The compression system comprises the initial processing portion 18 and the entropy encoding portion 19. The compression system is configured to encode uncompressed input data (e.g., data stream, pixel data) into a compressed output bit stream.

As described in the detail below, a communication protocol between the initial processing portion 18 and the entropy encoding portion 19 provides an efficient trade-off between the communication bandwidth and the complexity associated with the protocol. The data output from the initial processing portion 18 is compacted so that compressed data is transmitted from the initial processing portion 18 to the entropy encoding portion 19. Since the compacted data results in lower bandwidth requirements, entropy encoding may be performed remote from the rest of the processing performed by the compression system. For example, the entropy encoding portion 19 may be located at a separate network (e.g., different data center 10 as shown in FIG. 1) or network location than the initial processing portion 18.

In one embodiment, the compression system is configured for hybrid GPU (graphics processing unit)—CPU (central processing unit) implementation wherein the entropy encoding is implemented on a CPU and the other processing (e.g., motion estimation, transformation, and quantization) is implemented on ‘parallel-friendly’ GPU hardware. In one example, a data center service provider may house both CPUs and GPUs. The initial processing portion 18 of the encoding pipeline may be implemented on a GPU farm and the compacted output data from the GPU farm transmitted to a CPU farm for entropy encoding. Compaction of the data transmitted from the initial processing portion 18 to the entropy encoding portion 19 allows for each portion of the compression system to operate using independent processors.

It is to be understood that the network shown in FIG. 1 and described herein is only an example and that the embodiments may be implemented in networks having different network topologies or network devices, without departing from the scope of the embodiments.

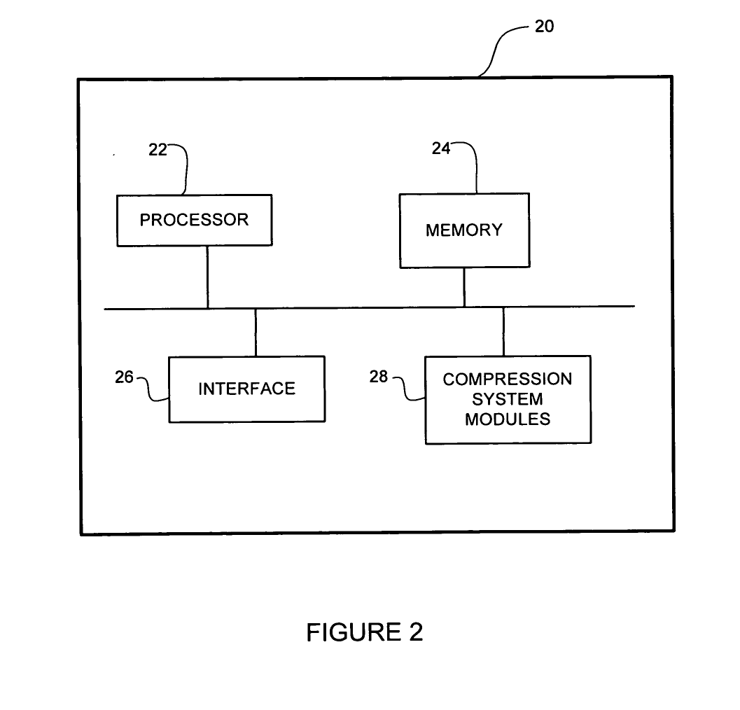

FIG. 2 is a block diagram illustrating an example of a network device 20 that may be used to implement embodiments described herein. The network device 20 is a programmable machine that may be implemented in hardware, software, or any combination thereof. For example, the embodiments may comprise a hybrid ASIC (application-specific integrated circuit) or FPGA (field-programmable gate array) based implementation for the initial processing portion 18, and software based implementation that runs on a CPU for the entropy encoding portion 19. The compression system may also be configured with the initial processing portion 18 implemented in software, the entropy encoding portion 19 implemented in hardware, or both portions implemented in software or hardware.

The network device 20 includes a processor 22, memory 24, interface 26, and compression system modules 28 (e.g., motion estimation, transformation, quantization, and compaction for the initial processing portion 18, or interpretation and entropy encoding for the entropy encoding portion 19). Memory 24 may be a volatile memory or non-volatile storage, which stores various applications, modules, and data for execution and use by the processor 22. Memory may also include encoding information (e.g., syntax elements, descriptors, values for syntax elements and information needed to encode them, state of independent syntax elements).

Logic may be encoded in one or more tangible computer readable media for execution by the processor 22. For example, the processor 22 may execute codes stored in a computer-readable medium such as memory 24. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium.

The interface 26 may comprise any number of interfaces (linecards, ports) for receiving signals or data or transmitting signals or data to other devices. The interface 26 may include, for example, an Ethernet interface for connection to a computer or network.

It is to be understood that the network device 20 shown in FIG. 2 and described above is only one example and that different components and configurations may be used, without departing from the scope of the embodiments. For example, the network device 20 may further include any suitable combination of hardware, software, algorithms, processors, DSPs (digital signal processors), devices, components, or elements operable to facilitate the capabilities described herein.

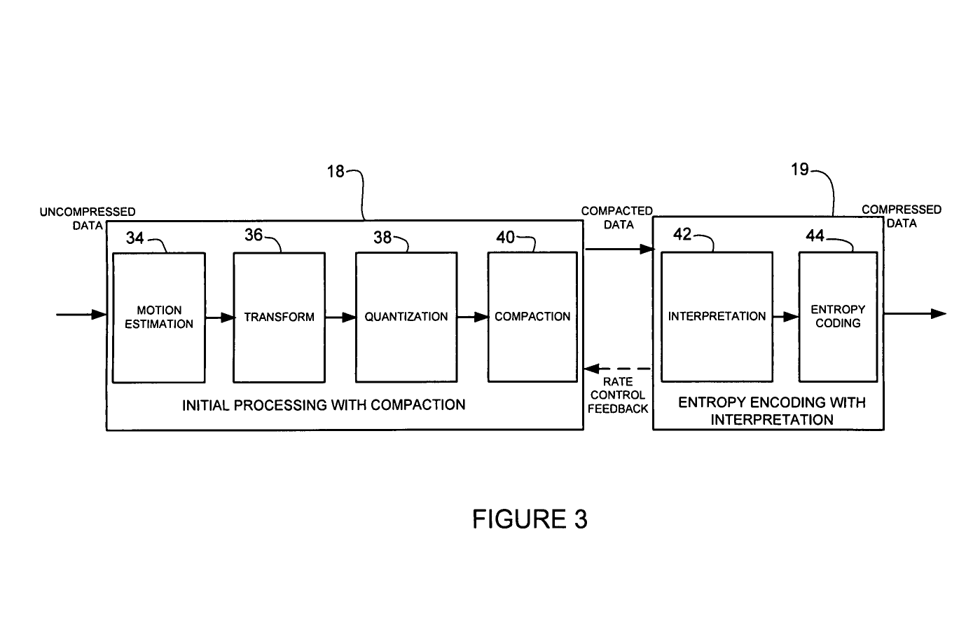

FIG. 3 illustrates an example architecture for a multi-processor implementation of the compression system. In one embodiment, the initial processing portion 18 includes a motion estimation module 34, transformation module 36, quantization module 38, and compaction module (layer) 40. The motion estimation module 34 may perform, for example, motion estimation, motion compensation, intra-frame prediction, or any combination thereof. The transformation module 36 forms a new set of samples from a combination of input samples to prevent the need to repeatedly represent similar values. The quantization module 38 reduces the precision used for the representation of a sample value (or a group of sample values) in order to reduce the amount of data needed to encode the representation. One or more of the modules 34, 36, 38 located in the initial processing portion 18 may be configured for parallel processing, such as disclosed in U.S. Patent Application Publication No. U.S. 2007/0086528, filed Oct. 6, 2006, for example.

The entropy encoding portion 19 includes an interpretation module (layer) 42 and entropy coding module 44. Entropy coding is a process by which discrete-valued source symbols are represented in a manner that takes advantage of the relative probabilities of the various possible values of each source symbol. The entropy encoder 44 may use context adaptive variable length coding (CAVLC) or context adaptive binary arithmetic coding (CABAC), for example.

Multiple independent processors are employed so that the entropy coding module 44 can be implemented separately from the rest of the processing (e.g., motion estimation, transformation, and quantization).

It is to be understood that the compression system illustrated in FIG. 3 is only an example and that the compression system may include additional, fewer, combined, or different processing modules, without departing from the scope of the embodiments.

The following example describes encoding of a video stream into a compressed bit stream using the modules shown in FIG. 3. A picture is first partitioned into fixed-size macroblocks that each covers a rectangular picture area. Macroblocks are the basic building blocks of a standard for which the decoding process is specified. Video compression solutions typically use 16×16 pixel macroblocks as the principal processing unit. The macroblocks are processed by the modules 34, 36, 38 in the initial processing portion 18. For example, samples of a macroblock may be spatially or temporally predicted and the resulting prediction transformed. The transformed coefficients are then quantized. The compaction layer 40 located at the initial processing portion 18 is used to compact (compress) data for transmittal to the interpretation layer 42 located at the entropy encoding portion 19. The interpretation layer 42 interprets the compacted data, which is then encoded using entropy coding methods. A compressed bit stream is transmitted from the entropy encoder. The entropy-encoded coefficients, together with side information required to decode the macroblock (such as the macroblock prediction mode, quanitizer step size, motion vector information describing how the macroblock was motion compensated, etc.) form the compressed bit stream. This is passed to a Network Abstraction Layer (NAL) for transmission or storage.

In one embodiment, rate control feedback is provided between the entropy encoding portion 19 and the initial processing portion 18. This may include, for example, various bit stream statistics such as number of bits generated from the encoding of a NAL unit by the entropy coding module 44, which are provided to the initial processing portion 18 to facilitate target bit-rate control.

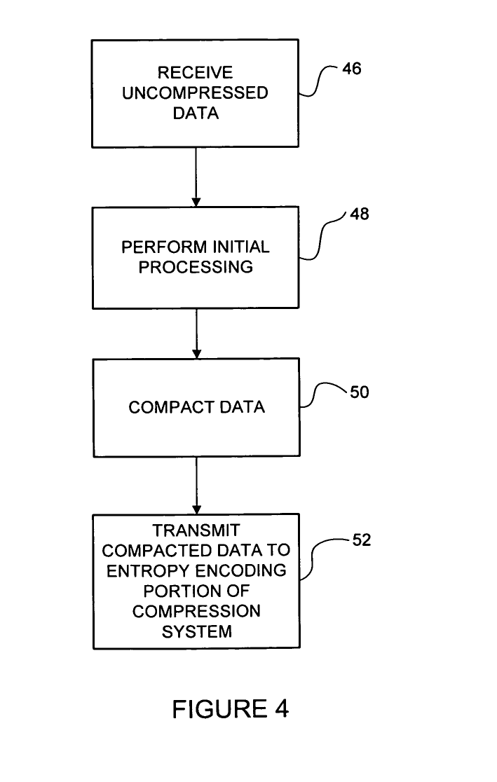

FIG. 4 is a flowchart illustrating an overview of a process for performing initial processing and compaction of data at a first network device 14 (FIG. 1), in accordance with one embodiment. At step 46, the initial processing portion 18 receives uncompressed input data (FIGS. 3 and 4). The initial processing portion 18 performs one or more processes (e.g., motion estimation and compensation, intra-frame prediction, transformation, quantization) to prepare the data for entropy encoding (step 48). The initial processing portion 18 then compacts the data at compaction layer 40 (step 50). The compacted (compressed) data is then transmitted to the entropy encoding portion 19 at a second network device 16 (step 52).

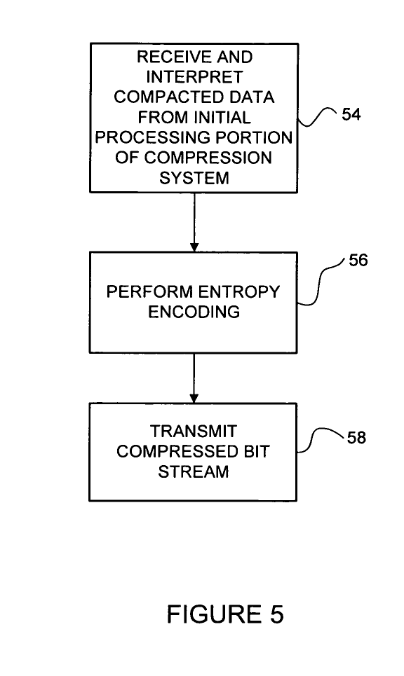

FIG. 5 is a flowchart illustrating an overview of a process for performing entropy encoding on compacted data received from the initial processing portion 18, in accordance with one embodiment. At step 54 the interpretation module 42 receives and interprets compacted data from the initial processing portion 18 of the compression system (FIGS. 3 and 5). Entropy encoding is performed at step 56. The compressed output bit stream is transmitted from the entropy encoder 44 at step 58.

It is to be understood that the processes shown in FIGS. 4 and 5, and described above are only examples and that steps may be added, reordered, or combined, without departing from the scope of the embodiments.

The following describes an example of a communication protocol (interface) between the initial processing portion 18 and entropy encoding portion 19 for a compression system that encodes data to generate bit stream data that conforms to ITU-T H.264 (ITU-T H.264 Series H: Audiovisual and Multimedia Systems: Infrastructure of audiovisual services—Coding of moving video). It is to be understood that this is only an example and that the compression system may also be used to encode data according to another standard, such as H.262, H.263, H.264, or other coding standard or format.

The H.264 standard defines the syntax of an encoded video bit stream and the method of decoding the bit stream. An H.264 bit stream comprises a sequence of NAL (network abstraction layer) units. The NAL unit is a syntax structure containing an indication of the type of data to follow (in a header byte) and bytes containing payload data of the type indicated by the header. The coded video data is organized into NAL units, each of which is effectively a packet that contains an integer number of bytes. The embodiments provide a NAL unit based interface for communication between the initial processing portion 18 and the entropy encoding portion 19. For each NAL unit, appropriate information (i.e., values for various syntax elements and any information needed to encode them) is provided by the initial processing portion 18 to the entropy encoding portion 19.

The following example applies to the syntax description for various NAL unit payloads as they occur in an H.264 SVC (scalable video coding) bit stream. SVC is described in Annex G of the H.264 standard and enables the transmission and decoding of partial bit streams to provide video services with lower temporal or spatial resolutions or reduced fidelity while retaining a reconstruction quality that is high relative to the rate of the partial bit stream.

Within the bit stream for a typical NAL unit payload, syntax elements that occur earlier can result in the conditional presence of syntax elements that occur later, depending upon their value. The former is referred to herein as independent syntax elements and the later as dependent syntax elements. This property may be referred to as intra-NAL unit syntax element dependency.

Across various NAL unit payloads, syntax elements that are indicated in some NAL units such as seq_parameter_set_rbsp( ) (see, for example, section G.7.3.2.1.2 of H.264) and pic_parameter_set_rbsp( ) (see, for example, section G.7.3.2.2 of H.264) can result in conditional presence of syntax elements in other NAL units such as slice_layer_without_partitioning_rbsp( ) (see, for example, section G.7.3.2.8 of H.264) depending upon their value. The former are referred to herein as independent syntax elements and the latter as dependent syntax elements. This property is referred to as inter-NAL unit syntax element dependency.

Derived variables associated with independent syntax elements from either of the above scenarios may result in conditional presence of other syntax elements, depending upon their value.

The size of an encoded NAL unit in conventional systems is variable for two reasons. First, the number of syntax elements indicated in a NAL unit payload can vary for reasons discussed above. Changing of the variable size to a fixed size is referred to herein as compaction. Furthermore, the number of bits associated with the encoding of a syntax element value varies depending upon the value of the syntax element. This is referred to as entropy encoding.

Based on the above, the embodiments use the following general framework for a NAL unit payload data input to the entropy encoding portion 19.

For every NAL unit payload to be processed by the entropy encoding portion 19, the input data can be thought of as a stream of bytes (or a packet). This packet represents the values of various syntax elements in the same order and with the same set of dependencies as the corresponding encoded version of the NAL unit payload depicted in section G.7.3 of H.264. In conventional systems, packets would be variable sized and represent bit encodings using various syntax element descriptors as set forth in H.264 (e.g., ae(v) (context adaptive arithmetic entropy coded syntax element) and ce(v) (context adaptive variable length entropy coded syntax element)). In the embodiments described herein, packets transmitted from the initial processing portion 18 to the entropy encoded portion 19 contain unencoded syntax elements (i.e., syntax element values that have not been entropy encoded).

For example, using CAVLC mode of H.264, in conventional systems the syntax element coeff token is encoded using VLC (variable length coding) table lookups. However, this syntax element takes at most 68 values and can be represented in 7 bits with fixed length encoding using the compaction described herein. The packet is decodable by the interpretation layer 42 at the entropy encoding portion 19.

Due to the property of inter-NAL unit syntax element dependency, the parsing of dependent syntax elements in the packet may necessitate maintenance of some state in the entropy encoding portion 19 corresponding to the independent syntax elements. Upon parsing of the packet, the values of all syntax elements will be known to the entropy encoding portion 19 and can be used in entropy encoding.

In one embodiment, the compaction at the end of the initial processing portion 18 and the interpretation at the beginning of the entropy encoding portion 19 provide a transmission bandwidth reduction benefit, without adding a lot of implementation complexity to the compression system. The fixed length encoding based compaction and interpretation described above provide significant bandwidth savings with little increase in total computation complexity.

The communication interface described herein provides bandwidth savings for communication between the initial processing portion 18 and the entropy encoding portion 19 due to the compaction gain while transferring the actual task of entropy encoding to the entropy encoding portion. In experimental results using the reference implementation of H.264 to measure gains that arise out of compaction and entropy coding for video sequences, it was observed that compaction at the initial processing portion 18 accounts for a significant portion of the overall compression gain from the compression system.

Although the method, apparatus, and system have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
receiving data for compression at a first network device comprising an initial processing portion of a compression system;
performing one or more processes to prepare said data for entropy encoding;
compacting said data; and
transmitting said compacted data to a second network device comprising an entropy encoding portion of the compression system;
wherein said first and second network devices comprise independent processors.

2. The method of claim 1 wherein said one or more processes comprise motion estimation, transformation and quantization.

3. The method of claim 1 wherein said first network device is located remote from said second network device.

4. The method of claim 1 wherein transmitting said compacted data comprises transmitting packets comprising fixed length encoding.

5. The method of claim 1 wherein said entropy encoding portion comprises an interpretation layer for interpreting said compacted data.

6. The method of claim 1 wherein transmitting said compacted data comprises transmitting network abstraction layer payload data.

7. The method of claim 1 further comprising receiving rate control feedback from said entropy encoding portion.

8. The method of claim 1 wherein performing one or more processes comprises utilizing a graphics processing unit and wherein said entropy encoding portion comprises a central processing unit.

9. An apparatus comprising:
a processor for interpreting compacted data received from an initial processing portion of a compression system, entropy encoding said data, and transmitting a compressed bit stream; and
memory for storing encoding information;
wherein the processor is independent from the initial processing portion of the compression system.

10. The apparatus of claim 9 wherein said initial processing portion is configured for performing motion estimation, transformation and quantization.

11. The apparatus of claim 9 wherein the apparatus is configured for operation remote from said initial processing portion of the compression system.

12. The apparatus of claim 9 wherein the apparatus is configured for receiving packets comprising fixed length encoding.

13. The apparatus of claim 9 wherein the apparatus is configured for receiving unencoded syntax elements.

14. The apparatus of claim 9 wherein the apparatus is configured for transmitting rate control feedback to said initial processing portion.

15. A compression system comprising:
an initial processing portion for processing received data to prepare said data for entropy encoding and compacting said data utilizing fixed length encoding; and
an entropy encoding portion for interpreting said data received from said initial processing portion and performing entropy encoding;
wherein compaction of said data reduces transmission bandwidth between said initial processing portion and said entropy encoding portion.

16. The compression system of claim 15 wherein said entropy encoding portion is implemented on a central processing unit and wherein said initial processing portion utilizes graphics processing unit hardware.

17. The compression system of claim 15 wherein said initial processing portion and said entropy encoding portion comprise independent processors.

18. The compression system of claim 15 wherein said processing comprises motion estimation, transformation, and quantization.

19. The compression system of claim 15 wherein said entropy encoding portion is configured for receiving network abstraction layer payload data.

20. The compression system of claim 15 wherein said initial processing portion comprises a plurality of parallel processors for performing one or more processes.
